(19) United States
(12) Patent Application Publication
(10) Pub. No.: US 2011/0094152 A1
(43) Pub. Date: Apr. 28, 2011

(54) NATURAL FIBER FOLDING POT

(76) Inventors: Wayne Thomas Toyama, Toronto (CA); Yohan Suriyampola, Burlington (CA)

(21) Appl. No.: 12/603,882

(22) Filed: Oct. 22, 2009

(51) Int. Cl. A01G 9/02; B29C 70/12; B29C 37/02

(52) U.S. Cl. 47/65.7; 264/257; 264/138

(57) ABSTRACT

A fiber pot, made of a combination of coconut fiber and natural latex rubber, is described that is able to be folded and compressed. Folding and compression of the fiber pots allows more pots to be placed within a shipping container thereby reducing shipping costs by approximately 75%. Because the folding fiber pots are made of coconut fiber and a natural latex rubber, they are 100% biodegradable and horticultural products contained within do not need to be removed prior to planting. This eliminates the root shock that horticultural products normally experience when planted in a different soil.

### FIELD

This disclosure relates to containers that are used to grow and hold horticultural products, especially root-bearing plants to be transplanted by the customer.

### BACKGROUND

Known horticultural containers are primarily made of plastic. A small percentage of the market consists of “green” containers made of wood fiber, corn, cocoa starch, or paper products. All known “green” containers are rigid and non-folding. In order to ship these containers, they are nested, one within the other, which is space consuming. The containers are solid and the horticultural product root systems remain confined within the container as the root systems grow and expand, resulting in the root system growing in a circular pattern and becoming “root bound”. Prior to planting, the horticultural products must be removed from the containers, and placed directly into a different soil, which can result in soil shock to the root system. In addition, the root system may need to be shaved to release the bound roots, which leaves the roots exposed and susceptible to diseases.

### SUMMARY

A fiber pot, made of a combination of coconut fiber and natural latex rubber, is described that is able to be folded and compressed. Folding and compression of the fiber pots allows more pots to be placed within a shipping container thereby reducing shipping costs by approximately 75%. Because the folding fiber pots are made of coconut fiber and a natural latex rubber, they are 100% biodegradable and horticultural products contained within do not need to be removed prior to planting. This eliminates the root shock that horticultural products normally experience when planted in a different soil.

Due to the density of the combination of the coconut fiber and latex rubber, the root system of the horticultural products are able to grow directly through the pots, eliminating the problem of bound roots. In addition, the roots are able to be air pruned, eliminating the need to shave bound roots. Air pruning also encourages the horticultural product to grow more roots, which results in healthier root systems. Horticultural products are generally fruits, vegetables, flowers, herbs, and ornamentals used for landscaping. Ornamentals can be, for example, trees, shrubs, bushes, evergreens, etc.

In one example, the coconut fiber and latex rubber are combined and formed to make a generally cylindrically shaped container with an open top and a closed bottom. In one embodiment, the top is slightly larger in diameter than the bottom, resulting in a slight taper of the generally cylindrically shaped container. The pot's lip and base may be made of two layers of the coconut and latex rubber which gives it strength, permeability, biodegradability and flexibility. The flexible nature of the materials allows the pot to be folded and for the pot to return to its original configuration. The top area of the container can be made of three layers of the coconut and latex rubber, giving the top area additional strength, helping to provide the pot the ability to return to its original configuration, e.g. to a circular shape, and for carrying, machine handling, or attachment of handles. Indentations may be formed on the bottom and sides of the container which allow the container to be easily folded. It should be realized that the containers can be made in any shape or size but it is preferred that the container be cylindrically shaped and have capacities of 1 to 10 gallons, for example, 1, 2, 3, 5, 7 and 10 gallons.

### DRAWINGS

FIG. 1 illustrates a “fully opened” fiber pot.

FIG. 2 illustrates an interior view showing the bottom and side wall of the fiber pot.

FIG. 3 illustrates an exterior view showing the bottom and side wall of the fiber pot.

FIG. 4 illustrates the bottom of the fiber pot detailing the indentation.

FIG. 5 illustrates a cross section view of an indentation in the fiber pot.

FIG. 6 illustrates a partially compressed fiber pot.

FIG. 7 illustrates a side view of a fully compressed fiber pot.

FIG. 8 illustrates a fiber pot without a lip.

### DETAILED DESCRIPTION

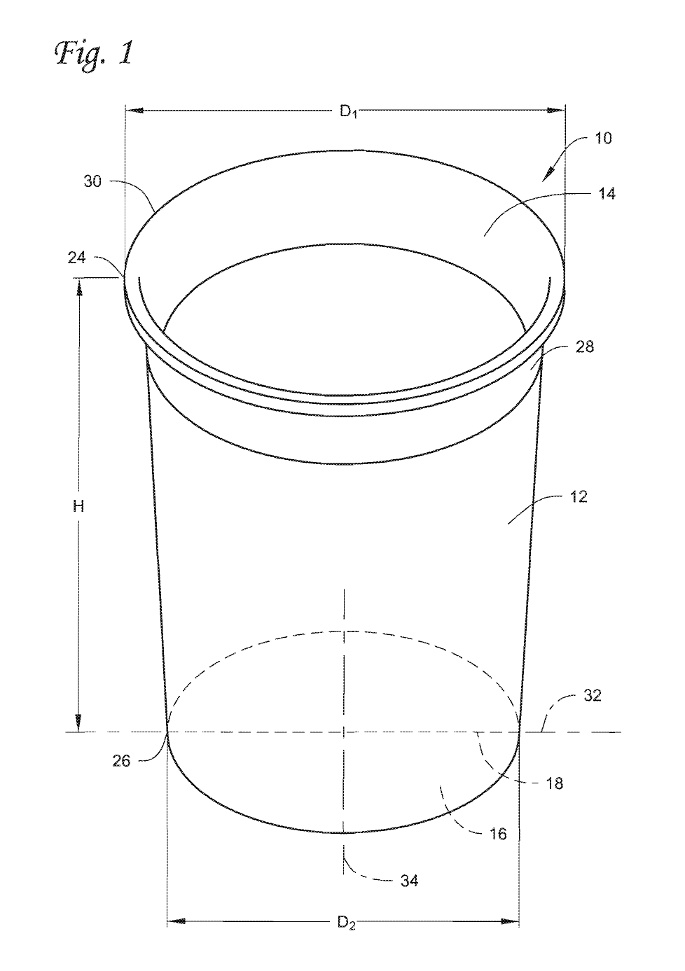

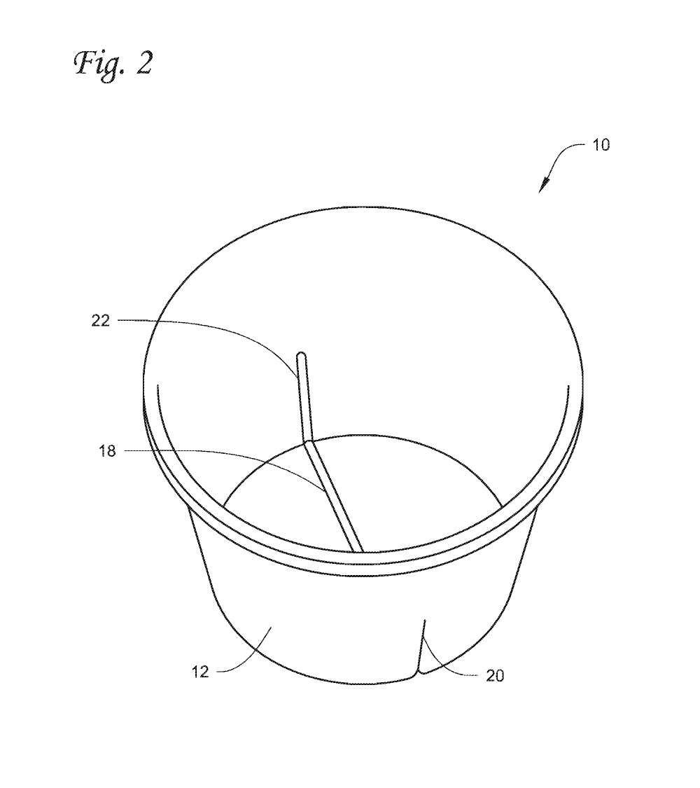

The fiber pot 10, as shown in FIGS. 1 and 2, is formed from a combination of compressed coconut fiber, known as coir, and latex rubber. Coconuts are a renewable resource and are readily available. The coconut seed is separated from the husk pulp.

The coir fibers and pith are found in the husk pulp and can be soaked to separate the fiber from the pith. The fiber is removed, cleaned and dried for use in making the fiber pot. Some advantages of using coir fiber is that it is a pH neutral material, is free of bacteria and fungal spores, and naturally contains a tanic acid which resists mold and termites.

Natural latex rubber is extracted from rubber trees and is used as a binding agent. Natural latex rubber is an elastomer (an elastic hydrocarbon polymer) that was originally derived from a milky colloidal suspension, or latex, found in the sap of some plants. Natural latex rubber is a polymer of isoprene—most often cis-1,4-polyisoprene—with a molecular weight of about 100,000 to 1,000,000. Typically, a small percent of other materials, such as proteins, fatty acids, resins and inorganic materials are found in natural latex rubber. Natural latex rubber is advantageous in that it is not brittle, it returns to generally its original shape, and it is non-toxic and biodegradable. In one embodiment, when the pots are above ground and in normal conditions, of the pot will take approximately two years to biodegrade. But, if the thickness of the pot is increased, the time to biodegrade will increase. It is to be realized that synthetic latex rubbers can also be used if they have been chemically treated to be biodegradable. But, chemically treating synthetic latex rubbers is costly, thereby making the use of these latex rubbers, for the purpose of making the fiber pots, less desirable.

In one embodiment, the coconut fiber is pressed into a large sheet and one side is sprayed with latex rubber. The coconut fiber and latex rubber sheet is then heated to 80 to 90° C. The sheet is turned over and the unsprayed side is then sprayed with latex rubber. The sheet is then re-heated to 80 to 90° C. and is roller pressed to the desired thickness. The large sheets can be cut to obtain smaller sheets of the desired shape and size. The sheets are press molded in the shape of the fiber pot including the indentations. Multiple layers can be incorporated during the press molding process to obtain a multi-layer fiber pot. The formed fiber pots are hand sprayed with heated latex and the top edge can be cut. The formed pots can then be folded and packed.

It should be realized by those skilled in the art that the embodiments described herein are not limiting and that even though the preferred embodiment is that of a fiber pot that is generally circular in shape, the fiber pot may be any shape including, but not limited to, square, rectangular, elliptical, etc.

An example of a folding fiber pot 10 will now be described with reference to FIG. 1-7. The fiber pot 10 includes a continuous side wall 12, a first end 14, a second end 16, a first indentation 18, a second indentation 20, and a third indentation 22.

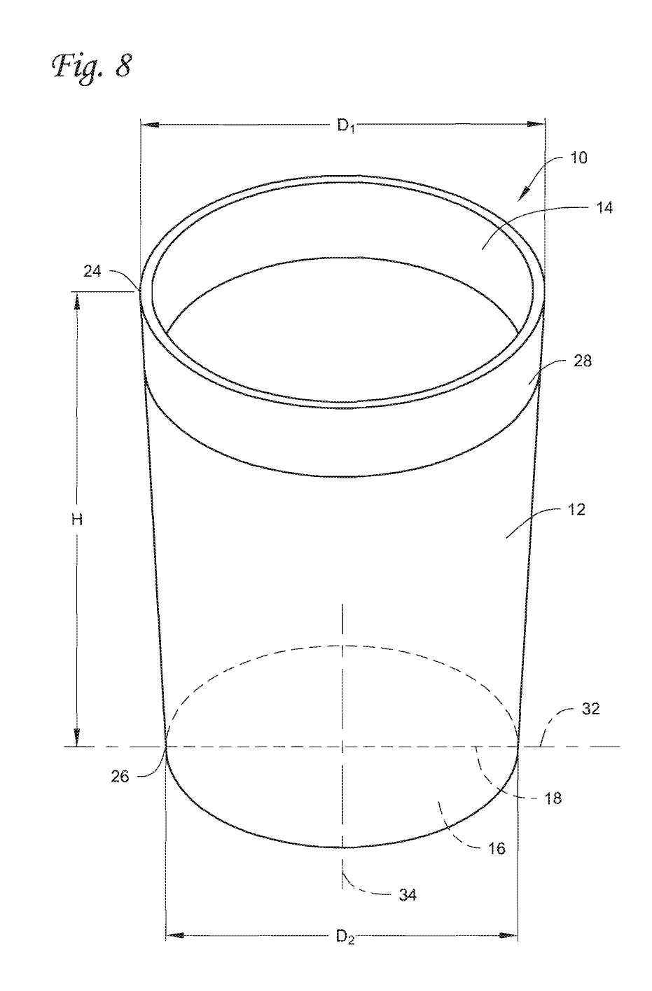

The continuous side wall 12, as shown in the embodiment of FIG. 1, includes a first end 24. Opposite the first end 24 is a second end 26. The side wall 12 material is a combination of coconut fiber and latex rubber. In one embodiment, the relative amount of coconut fiber is in the range of 70% to 80% and the relative amount of latex rubber is in the range of 20% to 30%. The material may be press molded in layers and the side wall 12 may contain a plurality of layers. In one example, the side wall 12 is made of two layers of compressed coconut fiber and latex rubber. Two layers allow for permeation of root systems and aids in the biodegradability of the product while providing the strength needed to contain the horticultural product and soil. The thickness of the walls is a determination of the life span of the fiber pot. Thinner walls will biodegrade faster than a thicker walled fiber pot. Once the pot is placed below ground level, the roots will penetrate the walls of the pot. The fibers will begin to deteriorate once placed below ground level and will open and disintegrate into the soil. Depending on needs, the wall thickness or number of layers may be adjusted. In one embodiment, the wall thickness is adjusted by the number of layers used. In another embodiment, the wall thickness is adjusted by using more material per layer. In addition, an area 28 extending approximately 1/20 to ¼, most preferably 1/10, of the height H of the side wall 12 from the first end 24 toward the second end 26 may be made of additional layers of compressed coconut fiber and latex rubber, e.g. three. This is done to provide additional stability, strength, and shape restoration properties. In one example, the first end 24 can include a lip 30. In another example, as shown in FIG. 8, the first end 24 can be provided as a straight wall without a lip 30. In another example, the side wall 12 can incorporate a plurality of handles relatively close to or at the first end 24.

The first end 14 is located at the terminus of the first end 24 of the side wall 12 and has a diameter D1. The first end 14 is open and provides access for the introduction of horticultural materials into the fiber pot 10.

In this embodiment, the second end 16 is made of a combination of coconut fiber and latex rubber, is located at the terminus of the second end 26, and has a diameter D2. The material is press molded in layers and the second end 16 contains a plurality of layers. In one example, the second end 16 is made of two layers of the combination of coconut fiber and latex rubber. Two layers allow for permeation of root systems and aids in the biodegradability of the product while providing the strength needed to contain the horticultural product and soil.

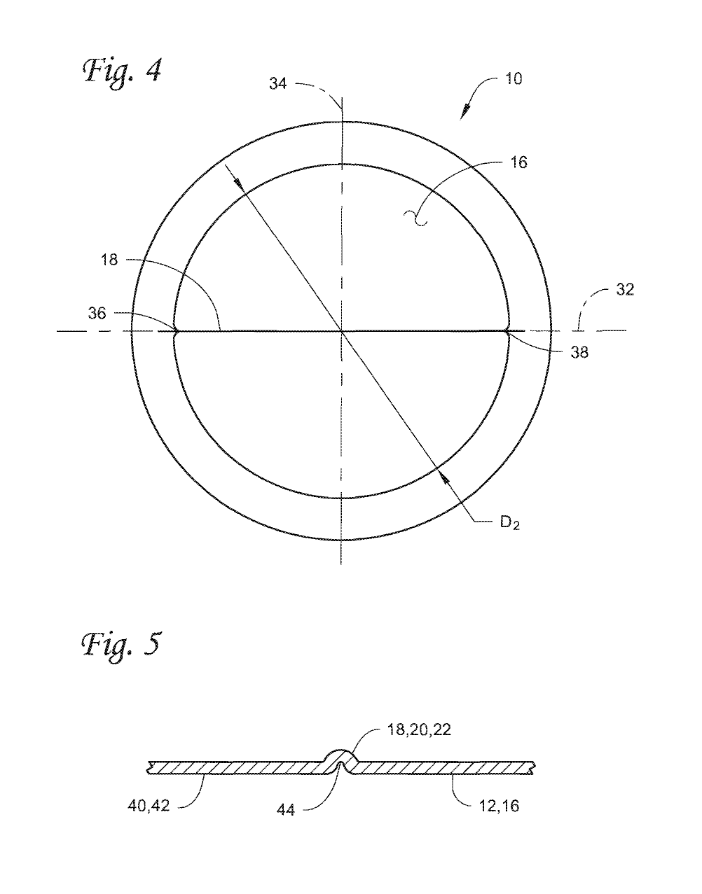

The second end 16, as shown in the embodiment of FIGS. 1 and 4, may be continuous and unitary with the terminus of the second end 26 of the side wall 12 thereby closing the container at the terminus of the second end 26. The second end 16 includes a first axis 32 and a second axis 34 that is perpendicular to the first axis 32. A first indentation 18 is disposed along the first axis 32. The first indentation 18 extends across the second end 16, preferably spanning the maximum dimension of the second end 16. The first indentation 18 has a first end 36 and a second end 38 opposite the first end 36.

The side wall 12 has a second indentation 20 and a third indentation 22 each extending from the second end 26 in the direction of the first end 24. The second indentation 20 and third indentation 22 can extend partially or fully from the second end 26 to the first end 24. In one embodiment, the second indentation 20 and third indentation 22 may extend approximately one-third of the distance from the second end 26 to the first end 24. In another embodiment, the second indentation 20 and third indentation 22 may extend approximately one-half of the distance from the second end 26 to the first end 24. The second indentation 20 extends from the first end 36 of the first indentation 18 and the third indentation 22 extends from the second end 38 of the first indentation 18. The indentations 18, 20, 22 allow for the folding of the fiber pot 10 in a predetermined manner, resulting in the fully compressed fiber pot 10 shown in FIG. 7.

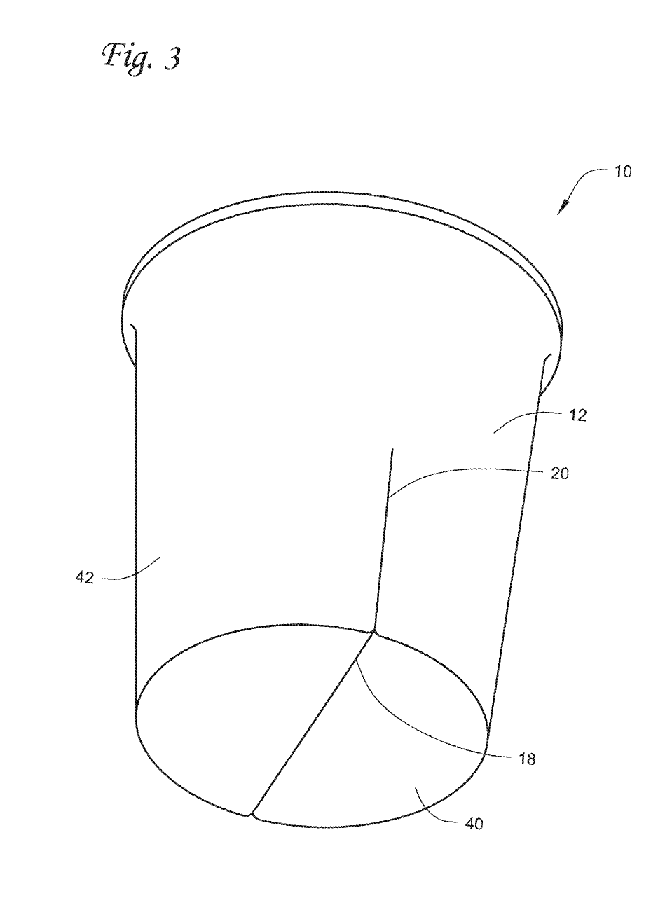

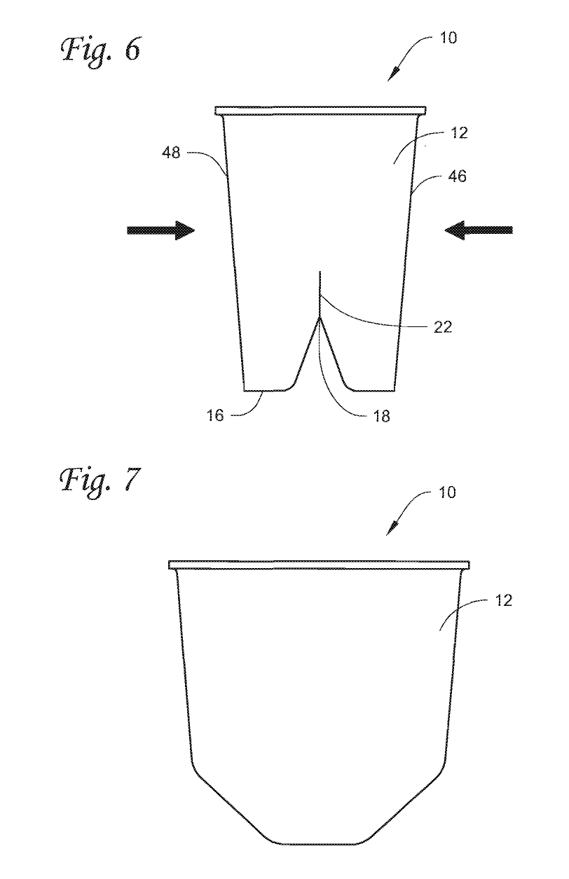

One example, as detailed in FIGS. 3 and 5, has the groove 44 of the first indentation 18 located on an exterior surface 40 of the second end 16 and the grooves 44 of the second 20 and third 22 indentations on an exterior surface 42 of the side wall 12. The purpose of this is direct the folding of the material in one direction towards the interior of the fiber pot 10. As shown in FIG. 6, the second end 16 is folded along the first indentation 18. The side wall 12 is folded using the second 20 and third 22 indentations and opposites sides 46, 48 of the side wall are brought together. The folding allows for the compaction of the fiber pot 10 so that a larger number of folded pots can be shipped versus unfolded pots, in the same size shipping container. For example, using a 40 foot (12.2 meters) high cube shipping container, it is possible to put 14,000 uncompressed three-gallon pots in each container. After compressing or folding a three-gallon fiber pot, it is possible to put 48,000 compressed three-gallon pots in each 40′ high cube shipping container, thereby reducing shipping costs by over 75%. In general, there is a 300-400% increase in the number of compressed pots that can be shipped in the same size container versus uncompress pots, regardless of the size of the pot.

Other aspects of the fiber pot 10 include that the diameter D1 of the first end 14 be equal to or less than the diameter D2 of the second end. The capacity of the fiber pot 10 generally is at least one gallon (3.5 liters), but can be any size. Preferred embodiments are of fiber pots with 1, 2, 3, 5, 7 and 10 gallon capacities.

The examples disclosed in this application are to be considered in all respects as illustrative and not limitative. The scope of the invention is indicated by the appended claims rather than by the foregoing description; and all changes which come within the meaning and range of equivalency of the claims are intended to be embraced therein.

1. A fiber pot comprising:
a continuous side wall that is closed, an open first end and a closed second end opposite the first end;
wherein the first end is open and the second end is closed;
said pot being made of a combination of compressed coconut fiber and latex rubber;
wherein the second end comprises a first indentation, said first indentation extending across the second end;
said first indentation having first and second ends;
the side wall comprises a second indentation extending from the second end in the direction of the first end of the side wall;
the side wall comprises a third indentation extending from the second end in the direction of the first end of the side wall; and
said second indentation extends from the first end of the first indentation and said third indentation extends from the second end of the first indentation.

2. The fiber pot of claim 1, further comprising a plurality of layers of the combination of coconut fiber and latex rubber.

3. The fiber pot of claim 2, wherein the side wall comprises two layers of the combination of coconut fiber and latex rubber.

4. The fiber pot of claim 2, wherein the side wall comprises three layers of the combination of coconut fiber and latex rubber at the first end of the side wall.

5. The fiber pot of claim 1, wherein the second indentation extends to a point that is about one-third of the distance from the second end to the first end of the side wall, and
the third indentation extends to a point that is about one-third of the distance from the second end to the first end of the side wall.

6. The fiber pot of claim 1, wherein the second end is folded along the first indentation, and
wherein the side wall is folded along the second and third indentations and opposite surfaces of the side wall are brought together

7. The fiber pot of claim 1, wherein the diameter of the second end the side wall is equal to or less than the diameter of the first end of the side wall.

8. The fiber pot of claim 1, further comprising a lip on the first end.

9. The fiber pot of claim 1, further comprising a plurality of handles attached to the first end.

10. The fiber pot of claim 1, wherein a capacity of the fiber pot is at least one gallon.

11. The fiber pot of claim 6, wherein a plurality of fiber pots are compressed in layers in a shipping container.

12. The method of making a fiber pot comprising:
forming a coconut fiber mat;
spraying the coconut fiber mat with latex rubber;
heating the coconut fiber and latex rubber;
pressing the coconut fiber and latex rubber mat to a first thickness;
molding the mats into the shape of a fiber pot having indentations in a bottom surface.

13. The method of claim 12, wherein more than one layer of the coconut fiber and latex rubber mat are molded into the shape of the fiber pot.

14. The method of claim 12, wherein the coconut fiber and latex rubber sheets are cut into predetermined sizes and shapes.

15. The method of claim 12, wherein a top edge of the fiber pot is cut.
